(19) United States
(12) Patent Application Publication
(10) Pub. No.: US 2013/0297399 A1
(43) Pub. Date: Nov. 7, 2013

(54) SYSTEMS FOR AND METHODS OF SECURITIZING ASSET-BASED SUPPLIER REBATE CASH FLOWS DERIVED FROM PROCUREMENT EXPENDITURES

(71) Applicant: OXYGEN FINANCE LIMITED, Leeds (GB)

(72) Inventors: David Brown, Bromley (GB); Mike Murphy, Cheltenham (GB); Keith Cotterill, Menlo Park, CA (US); Keith Ballantine, Northumberland (GB)

(73) Assignee: Oxygen Finance Limited, Leeds (GB)

(21) Appl. No.: 13/874,868

(22) Filed: May 1, 2013

Related U.S. Application Data
(60) Provisional application No. 61/719,671, filed on Oct. 29, 2012.
(60) Provisional application No. 61/641,608, filed on May 2, 2012.

(51) Int. Cl. G06Q 40/04

(52) U.S. Cl. CPC G06Q 40/04
USPC 705/14.34; 705/37

(57) ABSTRACT

Prospective variable early-payment rebates under a purchase agreement are expressed as income streams to a buyer through use of a rebate calculation process, and these flows are monetized and secured. The rebates are based on contractual obligations between a buyer and a seller. The rebates are “performance based” in that the earlier a buyer pays off its account with a supplier, the larger the rebate. These monetized rebates form a new asset class that can be sold just like any other financial instrument. The buyer, based on predictable cash outflows, can receive income from these future rebates sooner, allowing it to potentially fund large-scale projects. A computer system determines the amount of the rebates, rates them based on the likelihood that they will be received, and determines their current value. Investors purchase these instruments, in the form of bonds or notes, and receive payment in principle and interest. A third-party issues financial instruments, secured by the rebates.

### RELATED APPLICATION(S)

This application claims priority under 35 U.S.C. §119(e) of the co-pending U.S. provisional patent application Ser. No. 61/719,671, filed Oct. 29, 2012, and titled “A Method and Apparatus for Securitization of Asset Backed Supplier Rebates Cash Flows Derived from Procurement Expenditure,” which is hereby incorporated by reference in its entirety.

### FIELD OF THE INVENTION

This invention relates to the monetization of cashflows generated from commercial transactions undertaken between suppliers of goods and services and the corresponding purchaser of such goods and services (the client/buying organization or purchaser, collectively the “Organization”). In particular, this invention relates to the creation, determination and quantification, legal/commercial and corporate structuring, and the distribution of securities, the securities being secured on cashflows (rebates) collected from suppliers, in respect of procurement expenditure incurred by Organizations for goods and services ordered and delivered to them.

### BACKGROUND OF THE INVENTION

Securitization is a limited recourse financing technique that has been used extensively to finance future contracted cashflows of particular recognized asset classes (i.e. RMBS, CMBS, Auto Loans, CLO's & CDO's, Trade Receivables, unsecured personal loans and credit card receivables) via the issuance of securities that have security over the underlying cashflows. Only assets that have a known contracted payment obligation or have a tangible underlying asset have been securitized. Traditionally, securitization has involved the aggregation (pooling or bundling) of financial assets (loans/debt instruments) that have defined and contracted payment obligations for a known term. The process of aggregation (pooling) enables risk diversification so that the repayment of principal and interest under the securities is dependent on a portfolio of assets rather than a single asset. In this manner credit ratings ascribed to the securitized Bonds will be higher than that ascribed to a single asset included within the pool. It is common that the financial obligations being securitized are secured on underlying real assets—real estate, moveable assets over which the securization takes security in addition to the underlying cashflows. The funding for Securitization is typically delivered via the sale of publicly rated debt securities, issuance of Asset Backed Commercial Paper, or other fixed income financial instruments to investors (herein after collectively referred to as bonds or “Bonds”).

A well-known example of Securitization involves residential mortgages, which are agglomerated together into a single asset pool (the “Pool”), typically from a single originator. The corresponding securitized Bonds (the proceeds of which are used to fund/purchase the Pool of mortgages) may be divided into separate tranches (having different rankings of priority within the securitization) which are purchased by investors.

The pricing of securitized Bonds (i.e. the coupon payable on them) is determined by a number of factors, including the type of asset, the expected average life, and the actual legal final maturity. If the Bonds are split into separate tranches (credit tranching) whereby payments of interest and principal are only made on lower ranking tranches if and to the extent that scheduled interest and principal has been paid in full on more senior ranking tranches. Such credit tranching will also have a material effect on the pricing of the relevant tranches so that more senior tranches will have lower coupons than more subordinated tranches which incur higher risk. The valuation (pricing) of such securities is therefore related to the risk associated with the cash flows predicted from the underlying assets and the relevant ranking of the tranches within the capital structure of the securitized Bonds.

For multiple reasons, future cashflows have historically not been securitized for assets that have not been produced at the time of the Bond being sold to investors. Such reasons include the unpredictability of company performance, the uncertainty of future purchases, and the absence of defined and determined contractual obligations and underlying assets to act as security for the Bonds.

In particular the act (and method) of these cash outflows has never been recognized as a viable and tangible asset that can be characterized as income and consequently enable the net present value of such income to be leveraged for economic benefit by Organizations. In addition there has not been a composite process and method available with which to deliver this outcome.

### SUMMARY OF THE INVENTION

In accordance with the principles of the invention, the rebates that are expected to be generated from an Organization's projected expenditure will be securitized. The supplier rebates effectively reduce a proportion of the Organization's expenditure. The actual net payment to the supplier is lower than the gross invoice amount. The positive difference between the gross amount due (as set out in the invoice) and net amount paid to the supplier can be regarded as amounts of income which may be securitized. The predictability and certainty of such income is determined by the predictability of an Organization's procurement expenditure. If a proportion of future expenditure to third party suppliers can be re-characterized as sources of income, and furthermore if the ongoing need to spend with such suppliers can be seen as a requirement and therefore an asset, then it is possible to develop securitized assets based on the underlying spend and the income streams derived from applying rebates to such spend.

The Organization receives early-payment rebates on purchases of goods or services, the quantum of rebates will depend on, inter alia, the quantum of the organization's expenditure, the level of rebate agreed with differing suppliers and the number of and associated value of goods provided by suppliers. The contractual agreements for supplier rebates are either included within the supply and purchase agreement between the Organization (buyer) and their suppliers (“Participating Suppliers”) or are incorporated on a standalone agreement between the Organization and a supplier. The rebates are agreed for a period of time and are applied on a per-transaction per invoice basis. The projected values of these rebates are quantified, monetized, pooled together, and then sold in bundles to investors as a financial instrument secured by the rebates and the obligation of the Organization to pay the supplier net of the rebate deducted from the gross amount due, and pay the rebate to investors less the amount that is due to be retained by the Organization. This has created a new asset class, one based on an Organization's contractual agreement to pay a supplier earlier than it is obligated to do so at a lower amount than it would be otherwise required to pay. Thought of another way, the supplier agrees to rebate the Organization a proportion of its gross invoice amount in consideration for receiving early payment of their invoice either directly from the Organization or a third party that pays the invoice early in replacement of the Organization. The value of such future rebates will vary based on the amount of an Organization's procurement expenditure, the number of Participating Suppliers , the corresponding value of their respective invoices, the associated percentage rebate that is agreed with individual Participating Suppliers, the payment risk associated with the Organization, and so on. It is possible that various types of spend-related rebates may be aggregated into pools that have either directly or indirectly co-mingling of Organization spend, each reflecting such various levels of risk. Each pool will therefore be priced accordingly.

In virtually all circumstances the Organization will be a government agency or municipality, an large corporate entity that is either rated investment grade or has an implied investment grade rating, financial institution, all of whom have significant procurement expenditure, and from which significant rebates can be generated. There are no restrictions on how any Organization uses the proceeds of the securitization of supplier rebates. For example if the Organization is a municipality it can use the sale of the instrument to fund large-scale current projects such as schools, hospitals, roads, bridges, and other infrastructure.

The quantum that can be raised from the securitization involves determining, on a computer system using qualitative and quantitative assumptions and analytics, the total amount of early-payment and benefit capture rebates for future transactions made under one or more purchase agreements; determining, on the computer system, the net present value of the amount of the rebates; and issuing a financial instrument secured by the rebates subject to required levels of over-collaterlisation (haircut)/credit enhancement. The quantum of the early payment rebate degrades to the extent that an invoice is paid closer to the contractual payment date and the duration of the accelerated period is reduced. The early-payment rebates are applied to each of the future transactions on a per-invoice basis. Rebates are expected to be applied for invoices in respect of operational expenditures, manufacturing expenditures, capital expenditures, lease payments, or any combination of these.

In one embodiment, each of the Participating Suppliers included in early-payment and benefit capture is characterized by a rating score that provides a graded scale indicating the likelihood and confidence of their future supply to the relevant Organization. The current value of expected future rebates is determined by, among other things, weighting each of the rating scores by reference to the expected value (cost) of goods supplied and the expected acceleration of invoice payment days that the Organization will be able to achieve.

In one embodiment, one or more purchase agreements with Participating Suppliers may have one or more purchase restrictions, such as a limitation on a purchaser, a seller, a product, a service, a number of products or services purchased in a single transaction, a range of dollar amounts, a range of purchase dates, or any combination of these.

In another embodiment, the method also includes, for one of the one or more purchase agreements with Participating Suppliers provision for augmented services for transactions under the purchase agreement. Examples of augmented services include insurance services, foreign-exchange services, commodities services, or any combination of these. In addition at least one or more purchase agreements also contain volume purchase discount provisions. It is expected that the purchase agreements with participating Suppliers (in whatever form they may take) will include contractual trade terms (standard or otherwise) that determine when payment is due by the Organization under any invoice submitted by any Participating Supplier.

In a second aspect, a system for securitizing early-payment rebate cash flows includes a non-transitory computer-readable medium including a financial transaction services engine configured to determine a total amount of variable early-payment rebates for future transactions made under one or more purchase agreements with participating Suppliers; a calculator configured to determine a current value of the amount of the early-payment rebates; and an issuer established to sell a financial instrument (or draw under a loan facility made available to it), such as a bond or a note, secured on the early payment rebates.

### BRIEF DESCRIPTION OF THE DRAWINGS

The following figures are used merely to describe illustrative embodiments and are not meant to limit the invention. In the figures, the same label refers to an identical or similar element.

FIGS. 1A-D are graphs of early-payment rebate schedules, used to illustrate different embodiments of the invention.

FIG. 2 shows the steps of a method of processing a transaction in accordance with one embodiment of the invention.

FIG. 3 shows the components of a system for processing transactions and generating reports in accordance with one embodiment of the invention.

FIG. 4 shows a network-based system for processing transactions and generating reports in accordance with one embodiment of the invention.

FIG. 5 shows a table of payment restrictions in accordance with one embodiment of the invention.

FIG. 6 is a use case diagram for the interaction between a buyer, a supplier, and a system for calculating and applying variable early-payment rebates in accordance with one embodiment of the invention.

FIGS. 7-9 are process flows for authorizing and processing transactions in accordance with different embodiments of the invention.

FIG. 10 is a high-level diagram illustrating securitization of purchasing rebate cash flows in accordance with one embodiment of the invention.

FIG. 11 shows the steps of a process for issuing a financial instrument based on securitizing purchasing rebate cash flows in accordance with one embodiment of the invention.

FIG. 12 shows the steps of a process for analyzing forecast spends based on rebate cash flows in accordance with one embodiment of the invention.

FIG. 13 shows a table used to illustrate rating rebate cash flows in accordance with one embodiment of the invention.

FIG. 14 is a use case diagram for the interaction between a buyer, a supplier, an investor, and a system for securitizing variable early-payment rebates in accordance with one embodiment of the invention.

FIG. 15 shows the components of a system for determining forecast spends in accordance with one embodiment of the invention.

### DETAILED DESCRIPTION OF THE PREFERRED EMBODIMENT

In general, large corporations and public sector organizations have predictable spending for non-payroll procured goods and services, though they can be subject to levels of seasonality and cyclicality however these too may also be predictable. In order to maintain operational activities, a predictable level of purchasing can be budgeted and planned, by month, category, and sector. This typically includes capital, direct, indirect, and other types of purchasing.

These Organizations have predictable spending levels but historically this has only been treated as a cost and is typically regarded as primarily a cost-saving opportunity. The act (and method) of payment has never been recognized as an asset that can be leveraged for economic benefit. Since procurement expenditure is frequently the largest cost (or the second largest cost after payroll) and given the predictability for such expenditure the consequential rebates that can be generated represent a significant amount of new income for the Organization. If procurement rebates are also included as “benefits capture” the ability to garnish a proportion of these cash flows on a predictable and consistent basis further increases the amount available as income to the Organization. By doing this, the service is able to generate early payments and benefits capture rebates and pass these back to the Organization as income. Since such rebates are associated with highly reliable and predictable underlying cash flows, the service packages future rebates (savings), creating an information asset that can be used by financial partners to create a securitized asset class.

In operation, an Organization (the client) will enter into contractual relations with a seller using a financial transactions platform (FTP) and will pass accounts payable information (invoices ready for payment) to the FTP. These invoices originate from the supplier, who also has visibility to its transactions as they pass through the FTP. Early-payment rebates are calculated and stored in the FTP as required for each payment transaction, for subsequent action by the FTP and the Organization.

Current year early payment rebates can be forecast based on parameters stored in the FTP, including supplier data, segment, purchasing history, etc. The FTP will produce a forward-looking forecast of such rebate-oriented cash flows and present these in a multi-year format for analysis and usage by the Organization and platform partners and funders/investors.

This information is then compared with actual historic spending to align projected spending with historical levels to validate the accuracy and probability levels associated with the forecast. The combined information is then provided to financial partners to form the basis of a cash flow based securitization bundle—a financial markets suite of products that can be offered to market by licensed organizations in compliance with appropriate legal conditions and regulatory requirements.

The first part of this application describes a flexible early-payment rebate system that generates the cash flow by applying early-payment rebates on a per-transaction basis. The second part describes how these assets are securitized and thereby enable an Organization and other stakeholder groups to raise securitized funding in respect of them.

### Early-Payment Rebates

In accordance with present invention, a buyer and a seller, either directly or through a third party, negotiate a purchase agreement with early-payment terms. Under the agreement, the rebates are calculated on a volumetric basis determined as a proportion of the gross invoice value and captured (claimed) on the point of invoice payment or before. In other words, the rebates are provided prospectively, on a per-invoice basis, rather than retrospectively in aggregate. Detailed reports can then be provided to buyers, sellers, and any other parties involved in the purchase transaction relationship. The accompanying analysis and reporting enables visibility and transparency for each transaction, making reconciliation easier, and enables the entire service to be performed by a third party.

The agreement can include purchase restrictions that limit, for example, the types of products purchased, the total dollar amount of a purchase, and the suppliers. Under some agreements, Organizations or Participating Suppliers can also purchase services such as insurance for the products and a service to search for an optimal foreign exchange service and rate which can then be sold onto their suppliers—in an identical manner to how early payment is sold to Participating Suppliers. With these features an Organization's suppliers will have a greater propensity to adopt and use the early-payment program and, as a consequence Organizations will derive a greater level of early payment rebate income.

In practice, an Organization will establish a service provider relationship with a service and pass accounts payable information (invoices ready for payment) to it, over a network connection. The Organization will configure the service for each relevant supplier, to determine which rebates will be applied, to which products and product categories, at specified times. As one example, a 2% rebate may be applied only to purchases of gauze from company ABC, from Aug. 1, 2013, to Aug. 15, 2013. The rebate will be calculated for and applied individually to each invoice that meets these criteria. The rebates will be applied before or during the payment process. Other examples of configurations of services are described below.

As one example, a purchase agreement having a flexible or varying rebate is negotiated between a buyer and seller. The buyer receives one rebate if it pays in full 10 days before the full-payment due date, a better rebate if it pays in full 15 days before the due date, and a still better rebate if it pays in full 20 days before the due date.

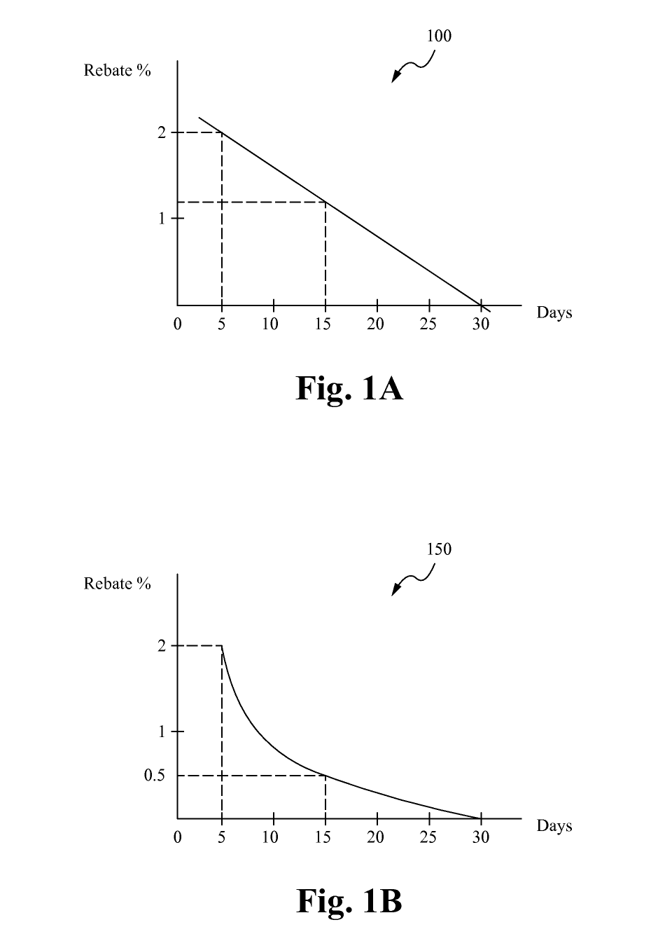

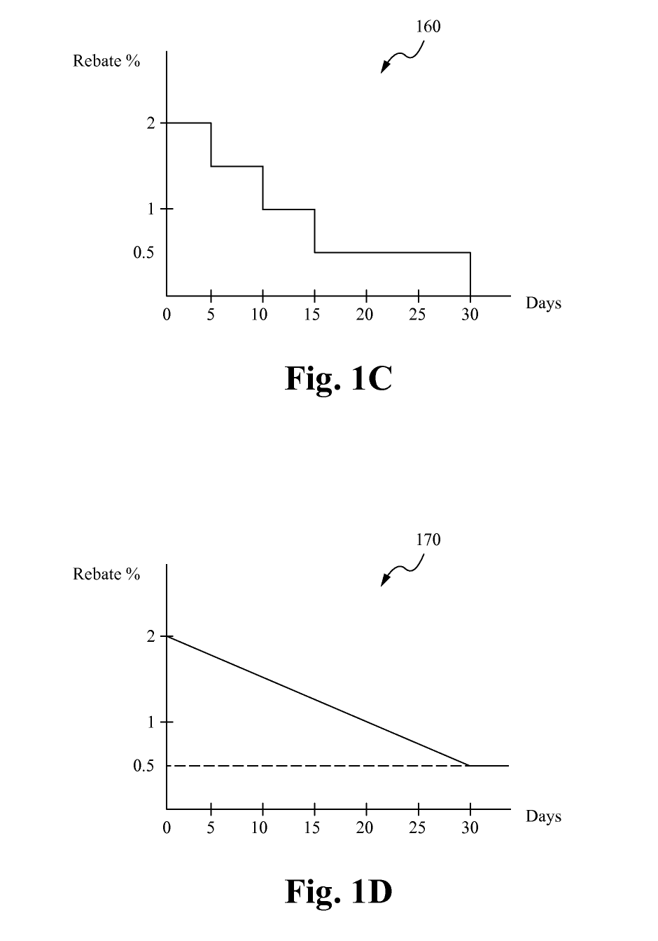

FIG. 1A is a graph 100 of a rebate versus days, illustrating a flexible rebate schedule in accordance with one embodiment of the invention. The graph 100 plots rebate versus days, with the days axis running from 0 (when a buyer receives an invoice) to 30 (the full-payment due date). The period from day 0 to day 30 is called the “invoice payment cycle.” As shown in the graph 100, if the invoice is paid in full by day 5, that is, 25 days before the full-payment due date, the buyer receives a 2% rebate. If the invoice is paid in full by day 15, the buyer receives a 1% rebate. The rebate continues linearly along this continuum. In other words, the rebate varies inversely with a number of days into the invoice payment cycle the account is paid in full. While the graph 100 is linear, it will be appreciated that the parties can negotiate different rebate schedules reflected in different graphs. For example, FIG. 1B shows a graph 150 having a non-linear relationship, in which rebates decrease at an accelerated rate. The schedules 100 and 150 describe “dynamic” rebates. FIG. 1C shows a graph 160 in which rebates decrease over time on a “tiered” or “stepped” basis. And FIG. 1D shows a graph 170 in which multiple rebates (one at 0.5% regardless of time, plus one linearly decreasing rebate) are calculated on a compound “fixed plus variable” basis.

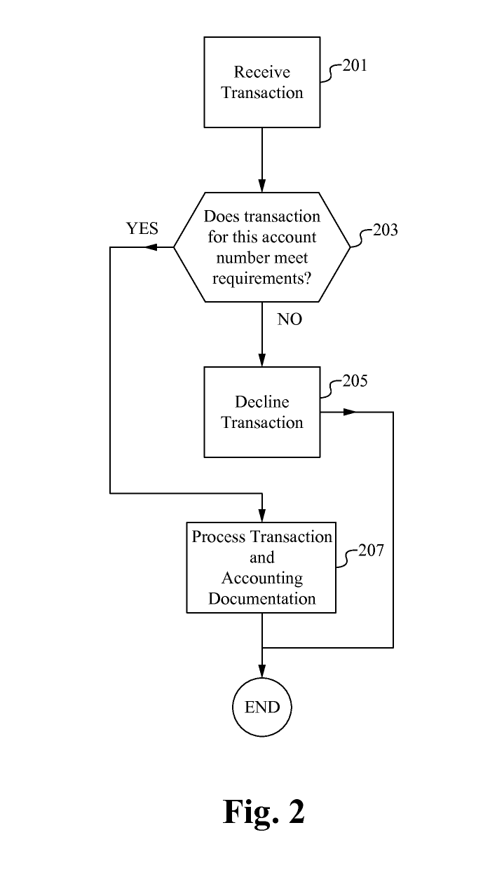

FIG. 2 is a high-level flow chart of steps 200 for a method of applying rebates in accordance with one embodiment of the invention. In the step 201, a transaction is received, such as on an electronic processing platform. The transaction is identified, in part, by an account number related to the individual buyer. In the step 203, it is determined whether the transaction for the particular account number satisfies the purchase restrictions, for example, whether the transaction is for less than a specified dollar amount. If it does, the method proceeds to the step 207, where the transaction is processed; otherwise, the method proceeds to the step 205, where the transaction is declined. As described in more detail below, in the step 207, the transaction can be processed by calculating a rebate, applying any augmented services, proposing a payment, executing the payment, generating appropriate accounting and tax documentation, or any combination of these steps. A payment may be proposed, for example, for payment by a third-party such as a bank. From both the steps 205 and 207, the method proceeds to the step 209, where it ends.

The steps 200 are merely illustrative of one embodiment. In other embodiments, as with all the flow charts in this disclosure, some of the steps can be deleted, other steps can be added, and the steps can be performed in different orders.

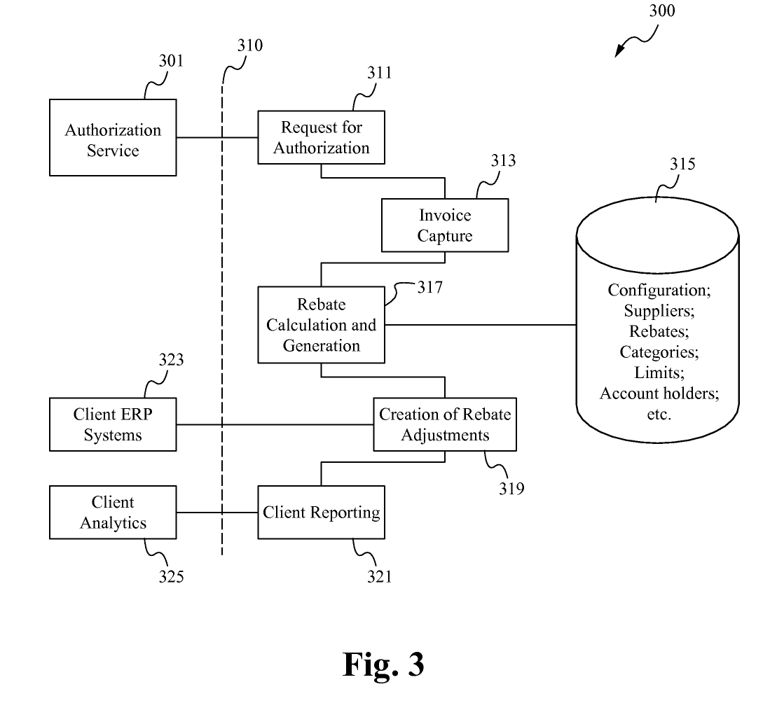

In one embodiment, rebate calculations and related operations are performed on a third-party service platform (a party other than the buyer or the seller) that communicates with both buyer-side and seller-side systems. FIG. 3 shows a process flow 300 for determining rebates in accordance with one embodiment of the invention, with the left side of a dashed horizontal line 310 showing those steps (301, 323, and 325) that occur on the buyer side and the right side of the line 310 showing those steps that occur on the service platform. In the step 301, a user or component on the Organization side calls a third-party authorization service to request authorization for a purchase, which the platform performs in the step 311. In the step 313, an invoice for the purchase is captured and in the step 317 a rebate is calculated and generated using configuration and account data stored in a database 315. The result of the step 317 is used to generate rebate adjustments in the step 319. Optionally, client reports are generated in the step 321, which in turn are used to produce client analytics in the step 325. The rebate adjustments are also input to client Enterprise Resource Planning (ERP) systems in the step 323.

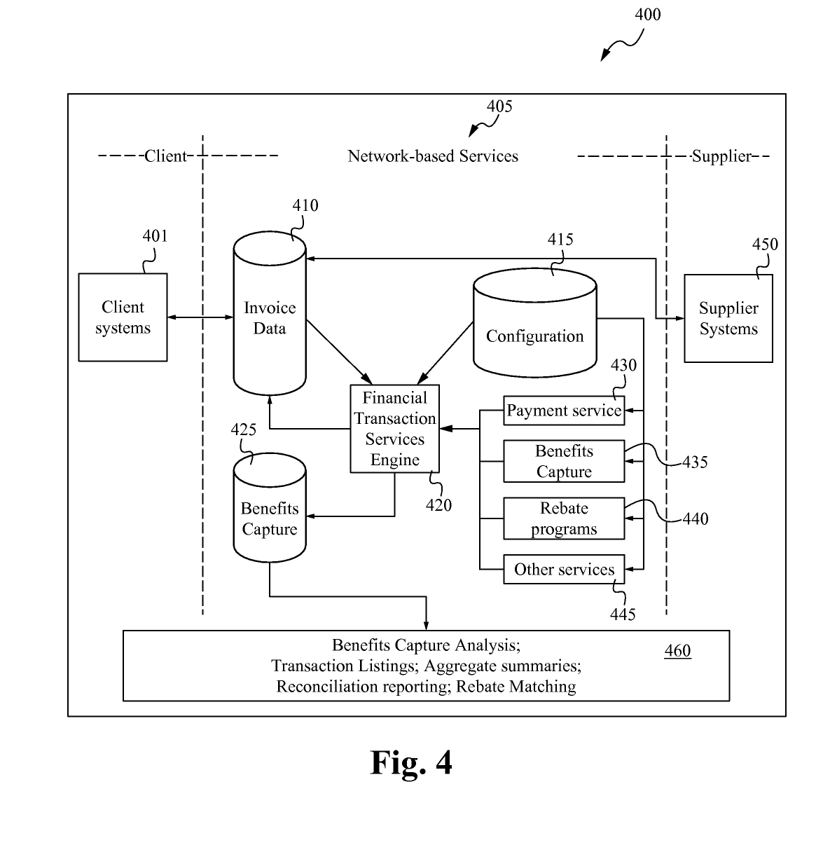

In one embodiment, the buyer-side systems, seller-side systems, and financial transaction platform are all coupled together over a network, such as shown in the networked financial services system 400 in FIG. 4. The system 400 includes client systems 401, supplier systems 450, and a financial transactions platform (FTP) 405. The platform 405 includes an Invoice database 410, a configuration database 415, a financial transaction services engine (FTSE) 420, a Benefits Capture database 425, a payment service 430, a benefits capture service 435, a rebate programs module 440, an “other services” module 445, and a component 460 for performing benefits capture analysis, transactions listings, aggregate summaries, reconciliation reporting, and rebate matching.

In operation, a buyer configures a rebate option on the platform 405 for a specific client (or buyer), supplier, and product (or product category), of a certain rate, in this example a flat rebate of 2.25%. The suppliers' system 450 submits an invoice for $10,000, representing 100 units of a product X at a unit price of $100 each. The invoice is stored in the Invoice database 410. The client systems 401 authorize payment of the invoice. The FTSE 420 reads configuration data in the Invoice database 410 to determine, for example, the rebate schedule, any purchase restrictions, and any other services that should be applied to the transaction. The FTSE 420 determines whether the purchase is allowed, for example by determining that purchase restrictions are met, and if they are, it invokes a rebate program 440 to calculate and apply any variable early-payment rebates, invokes any other services 445, invokes the “benefits capture” service 435 to capture all the benefits on the single transaction, that is, on a per-transaction basis, and invokes the payments service 430 to pay or authorize payment to the supplier. The benefits captured (e.g., rebates and other calculated net values) are stored in the Benefits Capture database 425, which can then be analyzed by the component 460 to generate listings, aggregate summaries, reconciliation reporting, rebate matching, and the like. Rebates are calculated for this and other appropriate invoices, typically in a daily batch or on an on-demand basis. The calculated net amounts can be passed to other services (e.g., 445), including early-payment services. On an on-demand or periodic basis, the benefits capture service 445 will provide detailed and summary reconciliation reports for the buyer and the seller. These reports assist with quantifying the total rebate earned and reconcile how calculations relate to each product and invoice.

Some embodiments, when determining rebates, account for regional tax laws. For those transactions that occur in countries that levy a value added tax (VAT) on each transaction, the invoice price and rebate are adjusted to account for the VAT. A similar adjustment is made for transactions that occur in countries that levy a sales tax. These adjustments are included in the detailed reports generated by the module 460.

In some embodiments, the platform 405 is hosted by a third party, which can charge a percentage of the benefits (e.g., rebates and foreign-exchange savings) as its services fee. The rebate system is thus “performance based” for both the buyer and the third party, in that both increase their profits the earlier the buyer pays.

In a preferred embodiment, the platform 405 includes a computer-readable medium storing computer executable instructions and one or more processors for executing those instructions. The computer-executable instructions perform, for example, the method steps 200 and 300 and any other steps performed by an FTSE and an FTP as described herein.

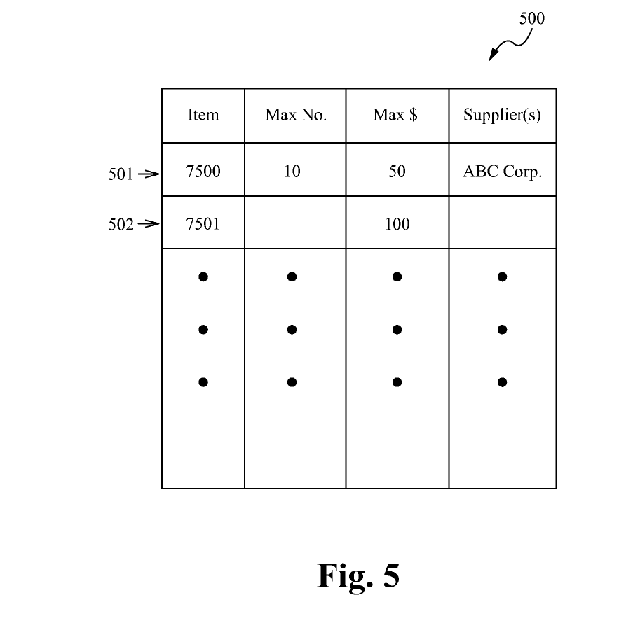

FIG. 5 shows a table 500 storing records 501, 502, etc. of purchase restrictions in accordance with one embodiment, such as stored in the Configuration file 415 for electronic processing. The table 500 is queried, for example, in the step 203 in FIG. 2. The rows in the table 500 include an item or product number field (column 1), a maximum number field (column 2), a maximum dollar amount field (column 3), and an approved supplier field (column 4). In this example, if a particular field is empty, it has no restrictions. Referring to the exemplary record 501, bandages (indicated by code 7500, column 1) have restrictions of a maximum number of 10 (column 2), a maximum dollar amount of $50 (column 3), and a restricted supplier, ABC Corp. (column 4). In other words, for a purchase of bandages (column 1) to be eligible for a rebate, no more than 10 can be purchased in a single transaction (column 2), for a total purchase price of no more than $50 (column 3), and can only be purchased from ABC Corp. (column 4). If the table 500 does not contain a product code, then that product is not covered by this particular rebate program. Thus, the purchase restriction stored in record 502 indicates that gauze (product code 7501) has no restrictions on the number for purchases but is limited to a total purchase price of $100.

It will be appreciated that the table 500 is used merely for illustration. Tables with other formats and with more or less information can be used in accordance with the present invention. Furthermore, while many of the examples discuss purchasing products, it will be appreciated that services can also be purchased under rebate programs in accordance with the invention.

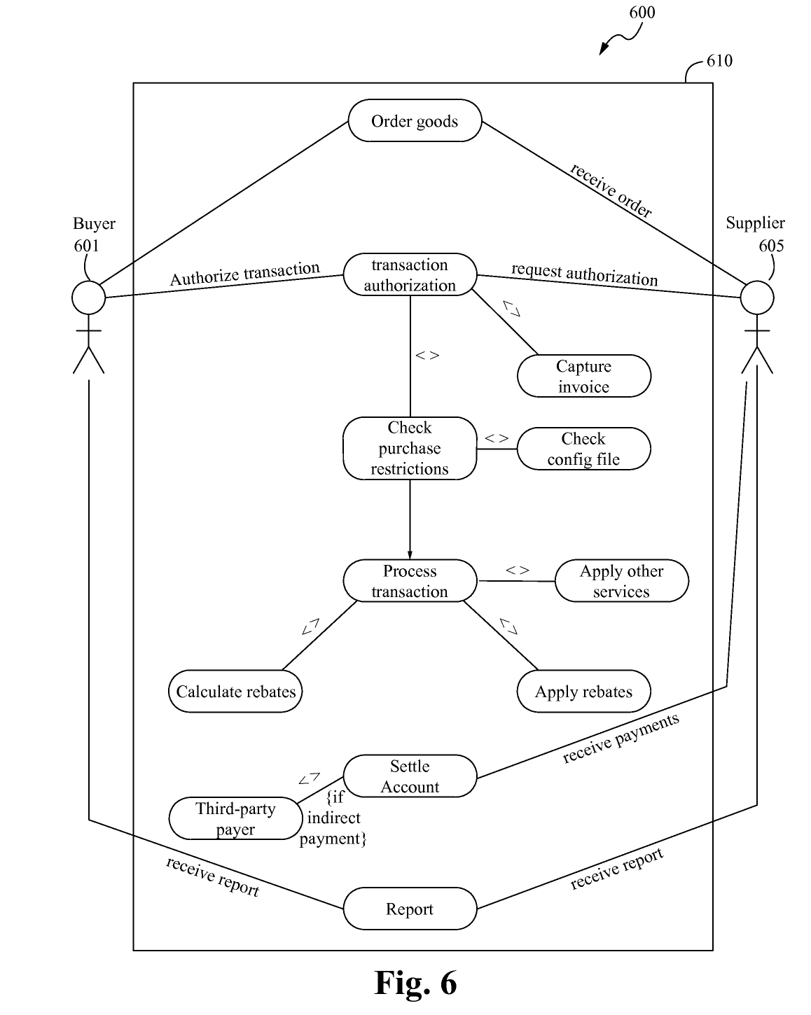

FIG. 6 is a use case diagram 600 illustrating the interaction between a buyer 601, a supplier 605, and an FTSE platform 610 for processing transactions in accordance with one embodiment of the invention. Those skilled in the art will recognize that paired angle brackets (<>) indicate “extending” an action. The use case diagram 600 shows that when the buyer 601 orders goods, the supplier 605 receives the order. The supplier 605 requests authorization of the transaction, and when the buyer 601 responds with an authorization, the platform 610 captures the invoice and checks purchase restrictions, which are found, for example, by querying a configuration database. The platform 610 processes the transaction by calculating the rebates and applying them and any other services to the transaction. The account is settled by the buyer paying the supplier directly or by instructing a third party to do so. The system can generate reports for both the buyer and the supplier.

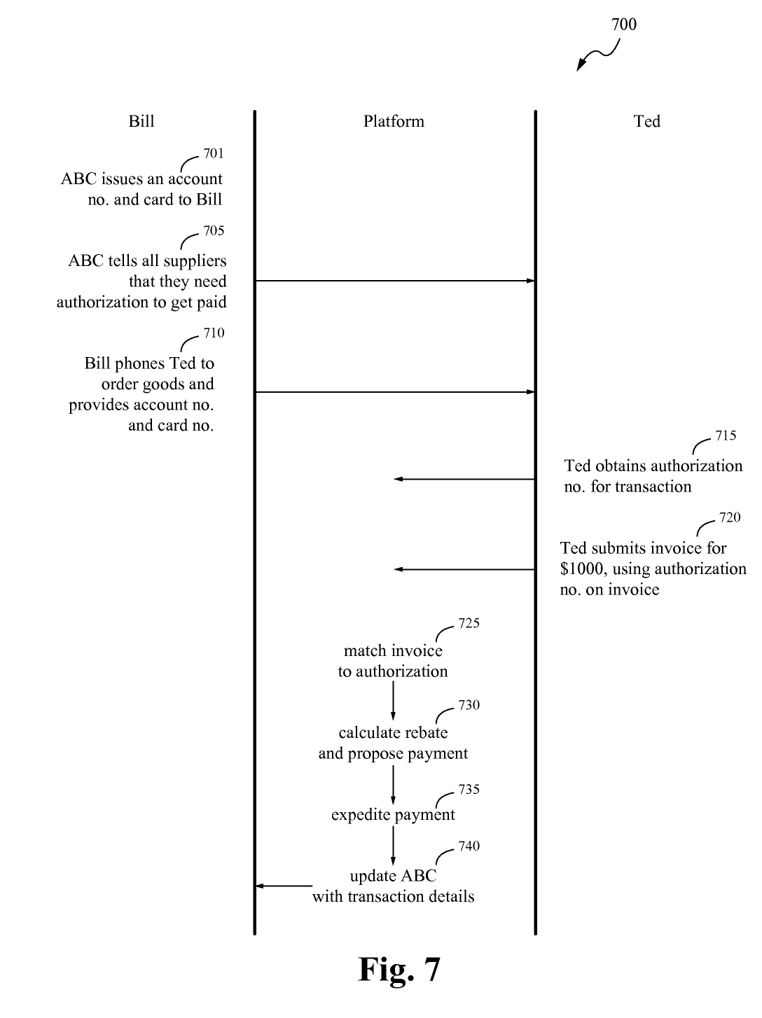

FIGS. 7-9 are process flow diagrams for different scenarios, illustrating how rebates are calculated and applied for different types of spend in accordance with the principles of the invention. In these examples, authorizations take place before any transaction processing enters the network. In these examples, Bill, an employee of company ABC, is issued a rebate card or account number (described in more detail below) for making purchases under a purchase agreement, such as discussed above. Each rebate card has a company account number that identifies the company and a card number that identifies, among other things, a particular employee of the company, such as Bill.

Referring to FIG. 7, ABC issues a rebate card to Bill (701). ABC may notify all suppliers that they must have an authorization number to get paid for any transactions (705). Bill telephones a supplier, Ted, and makes a purchase, providing the company and card account numbers (710). Ted obtains an authorization number for the transaction (715) and, using the authorization number, submits an invoice for the amount of the transaction (720). The financial transactions platform (FTP) matches the invoice to the authorization (725), calculates the appropriate rebate(s) and proposes a payment (730). The FTP expedites the payment (735) and updates ABC with the transaction details (740).

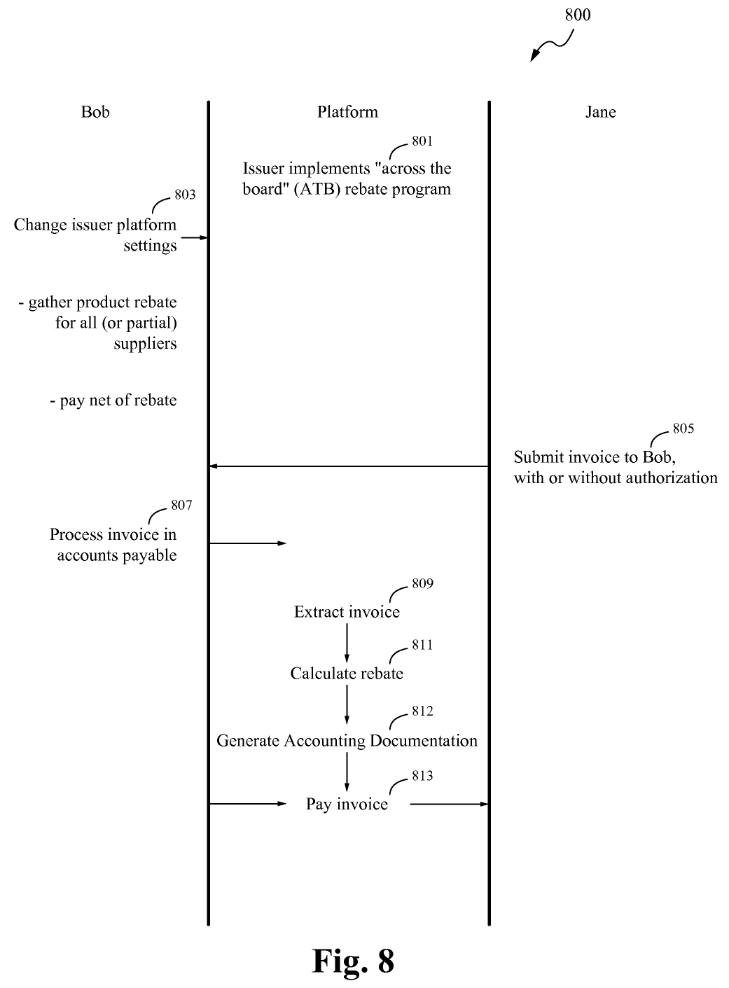

FIG. 8 shows a process flow 800 for an “across the board” (ATB) rebate program. In this example Bob, the CFO of company ABC, wants to generate profit-and-loss savings en masse. Bob asks an issuer to implement the ATB rebate program, which will be limited to (for example) consumables only. The issuer implements the ATB rebate program (801) with purchase restrictions for Bob. ABC changes the issuer's platform settings (803) by (a) gathering product rebates (e.g., 3%) for all supplies or partial supplies and (b) paying the invoices presented net of rebates. Jane, an employee of the supplier XYZ, submits an invoice to Bob, with or without authorization (805). Bob processes the invoice in accounts payable (807). The FTP extracts the invoice (809), calculates the rebate(s) (811), generates the appropriate accounting and tax documentation (812), and pays the invoice (813).

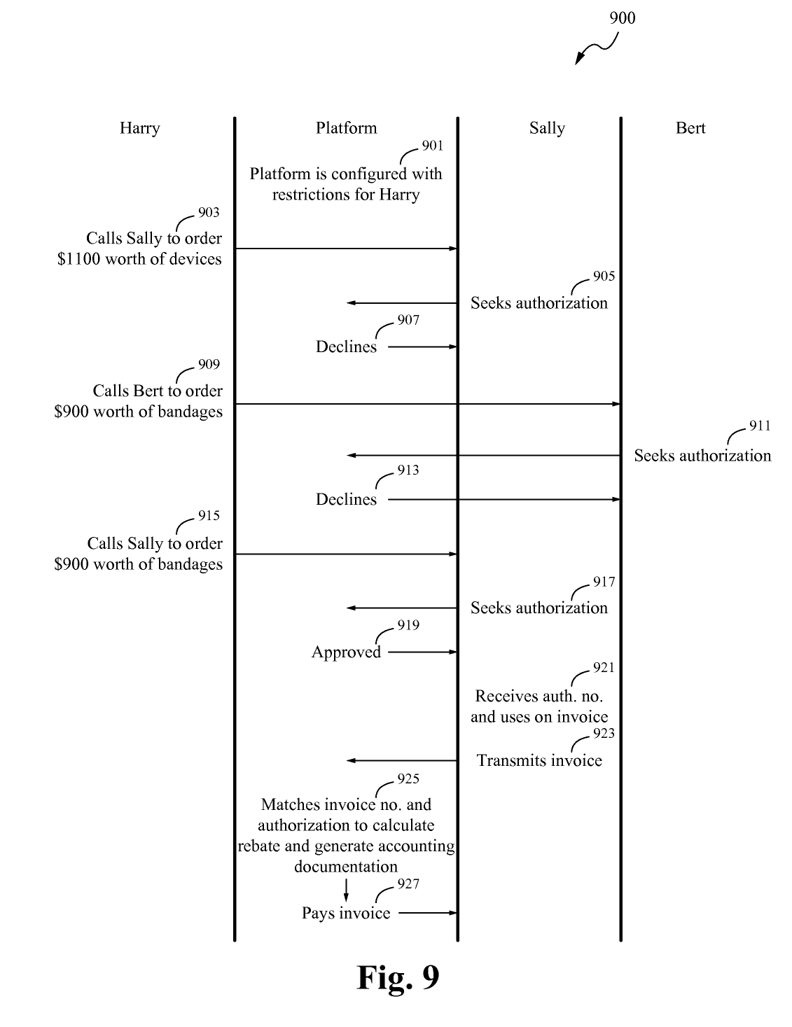

FIG. 9 shows a process flow 900 using purchase restrictions in accordance with embodiments of the invention. In this example, Harry, an employee of ABC, is restricted to certain products, suppliers, and dollar amounts (901): Harry can buy only bandages and devices from the supplier Sally; Harry can buy only medical supplies from the supplier Bert; Harry cannot make any single transaction over $1,000; and Harry's total transactions in one month cannot exceed $10,000. As explained in detail below, these restrictions can be stored in a configuration or other database for electronic processing.

Referring to the flow 900, Harry calls Sally to order $1,100 worth of devices (903). Sally receives this order and requests authorization (905). Because this transaction is for more than $1,000, the request is declined (907). Harry calls Bert to order $900 worth of bandages (909). Bert receives this order and requests authorization (911). Because Harry is not authorized to order bandages from Bert, this request is declined (913). Harry again calls Sally, this time to order $900 worth of bandages (915). Sally receives this order and requests authorization (917). This time, because Harry is authorized to order $900 worth of bandages from Sally, this request is approved (919). Sally receives an authorization number and places it on her invoice (921), and transmits this invoice for processing (923). The FTP matches the invoice number and the authorization to calculate the rebate and generates accounting and tax documentation (925) and then pays the invoice (927).

It will be appreciated that the process flows 700, 800, and 900 are merely illustrative. As one modification, in the process flow 900, ABC rather than the FTP pays the invoice in the step 927. Those skilled in the art will recognize other modifications that may be made in the spirit of the invention.

### Securitization

As recognized by the principles of the invention, an Organization can determine and predict the expected level of Participating Supplier rebates that represent new and incremental income from the Organization's procurement activities, but without altering its purchasing activities or requiring capital investment. The income can be identified and predicted with a high degree of accuracy. This enables the Organization to issue limited resource securities, which are secured on the Organization's right to collect rebates from Participating Suppliers.

This new securitization differs significantly from traditional securitization in that it is secured over obligations that are dependent on future activity that has not necessarily occurred at the time that the Bonds are issued. The securitization is based on a new type of asset class: early payment rebates that are dependent of future procurement activity. A platform in accordance with the principles of the invention provides visibility to these expected cash flows within a contractual context, allowing the segmentation, packaging, and securitization of these cash flows.

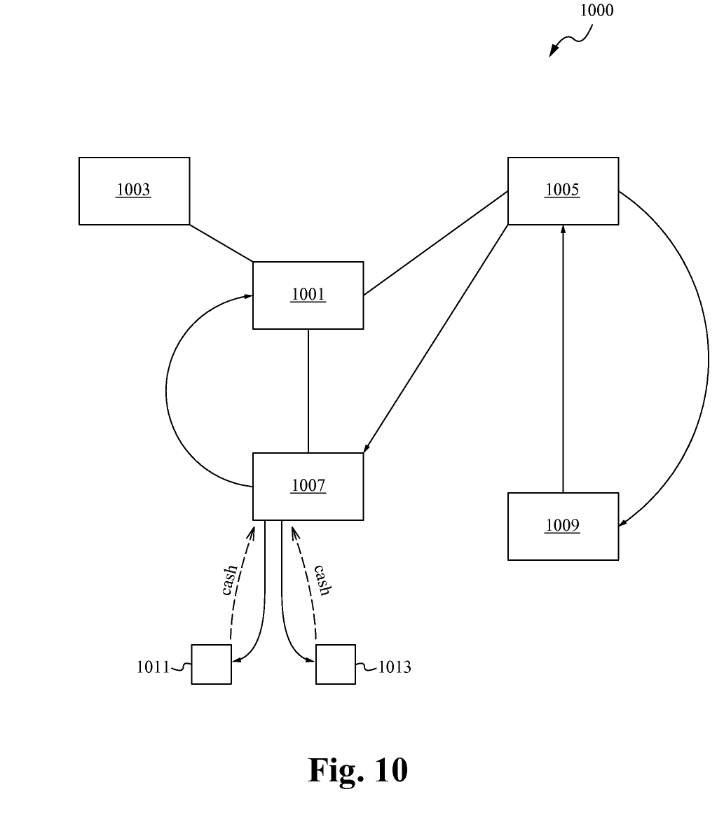

FIG. 10 is a high-level diagram 1000 illustrating how rebate cash flows are securitized in accordance with the principles of the invention. The diagram 1000 shows a third-party 1003 that brings on board suppliers to an early-payment rebate program, such as described above. Under this program, a buyer 1005 agrees to purchase goods from a supplier 1009 and pay the invoice earlier than it is contractually obligated to do so in exchange for a rebate from the Participating Supplier. The earlier in the billing cycle the Organization 1005 pays its invoice/account with the supplier 1009 in full, the larger the rebate. For example, if the Organization 1005 agrees to pay its account in full 10 days before the due date, it will receive a 2% rebate on a per-transaction basis, that is, on each transaction when it buys the goods. In accordance with the principles of the invention, these rebates are securitized, such that they can be bundled and sold as financial instruments. The calculation of variable early-payment rebates is discussed more fully below.

In the embodiment of FIG. 10, the platform 1001 calculates the rebates, which are assets. In one embodiment, the platform 1001 is the financial transaction services platform (FTP) 405 of FIG. 4. The supplier 1009 transmits the rebates to a third-party 1007, a dedicated funding vehicle (also referred to as a “special purpose vehicle” or “SPV”) that receives all of the [net] rebates. The SPV 1007 combines all the rebates for securitization. Investors 1011 and lenders 1013 purchase financial instruments secured by the assets and, as payment, receive principle and interest. In this model, the buyer 1005 is referred to as the “originator,” because it originated the transaction by placing an order with the supplier 1009. The SPV 1007 is referred to as the “issuer,” and the platform 1001 is called the “servicer,” because it brings the parties together to make the whole securitization process possible. In one embodiment, a party that hosts the platform 1001 receives as its fee a percentage of each rebate, which itself can be securitized.

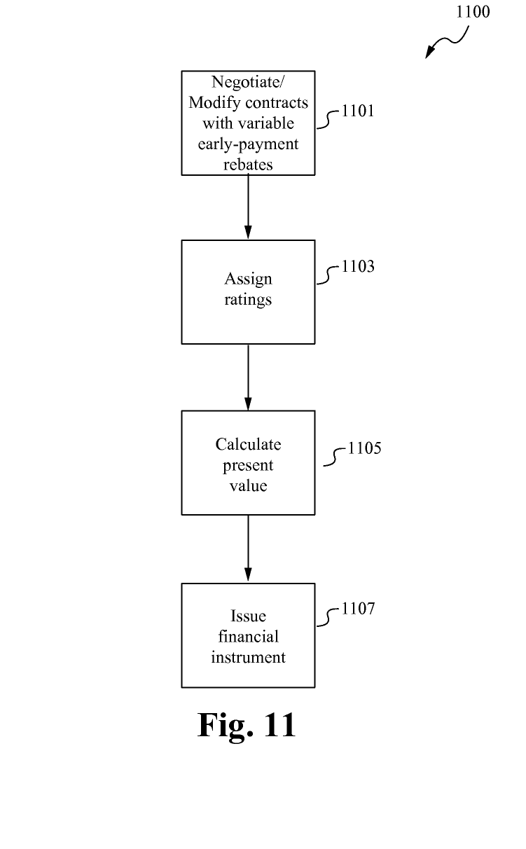

FIG. 11 shows the steps 1100 of a process for issuing financial instruments secured by prospective variable early-payment rebates in accordance with one embodiment of the invention. In the step 1101, a contract containing a variable early-payment rebate is negotiated between a buyer and a seller, or an existing contract is renegotiated to contain variable early-payment terms. The contract may have a minimum-volume term or alternatively predicted expectations can be determined for supply volume that, together with the amount of each rebate, is used to determine the total expected value of the rebates earned over the life of the contract. The two parties can negotiate directly or through a third party, such as the third party 1003 in FIG. 10. As one example, the parties negotiate that if a buyer pays its account in full 10 days into a billing cycle, it will receive a 2% rebate.

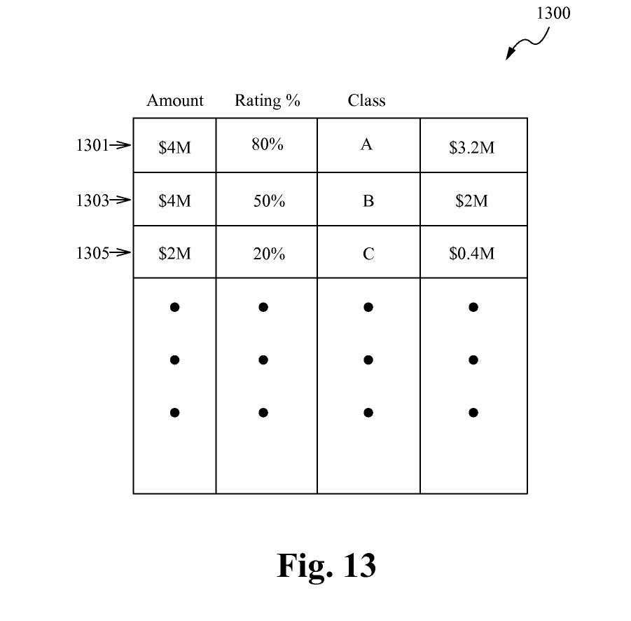

Next, in the step 1103, each rebate or class of rebates is assigned a rating score, discussed more fully in FIG. 13. This rating reflects the probability that the rebate will accrue. For example, one class of rebates refers to purchases for a buyer that has historically paid too late in a billing cycle to receive an early-payment rebate. Based on this trend, the expected value of this rebate is much less than 2%. This smaller expected value, characterized by a lower “rating,” is reflected in a decreased present value of the rebate. Next, in the step 1105, all the rebates in a particular bundle are weighted, as discussed below, combined into a bundle, and the bundle's present value is determined. This present value reflects how much investors will pay for it today. Finally, in the step 1107, a financial instrument is issued, securitized or “backed” by the prospective rebates.

In one embodiment, the steps 1103, 1105, and 1107 are performed on the SPV 1007 of FIG. 10. Preferably, the SPV 1007 includes a computer-readable medium storing instructions for performing the steps 1103, 1105, and 1107, and one or more processors for executing those instructions.

Those skilled in the art will recognize many ways to determine a current value of a prospective rebate or other cash flow based on such things as interest rates, market fluctuations, and the probability that the buyer will actually make contracted purchases and thus receive the rebate. As one example, an investor may decide to pay $8 million today for a predicted cash flow of $10 million over the next 5 years.

In general, investors rely on ratings to determine whether an asset is a low- or high-risk asset and thus how to monetize expected cash flows. Before investors invest in such securitized assets, they must have confidence that ratings scores attributed to Participating Suppliers and the consequential determination of the expected quantum of rebates are accurate.

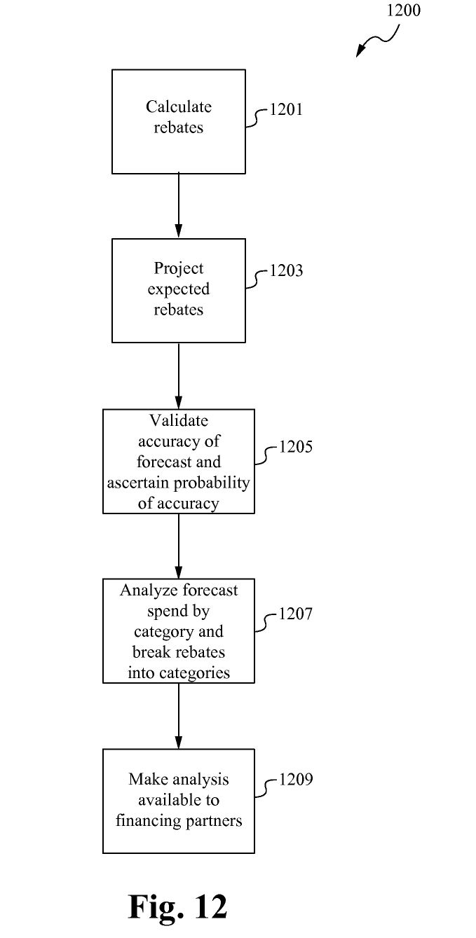

The ratings scores will incorporate many factors. As one example, ratings are determined by historical trends of payments by a particular Organization. If, under previous purchase agreements a buyer has consistently paid invoices early enough to receive a 2% rebate, the probability is high that it will continue to be able do so in the future. This confidence level indicates a higher current value of a rebate and is thus important information for investors. For this reason, historical trends are collected and tracked to determine ratings. FIG. 12 shows the steps 1200 of a process for using these trends and ensuring their accuracy. In the step 1201, any rebates are calculated and presented as incurred. Next, in the step 1203, a projection of expected rebates based on planned activities and supplier rebates is provided. In the step 1205, the forecast is matched with historical spending records to validate the accuracy and ascertain the probability of the forecast accuracy. In the step 1207, the forecast spend is analyzed by category of probability, based on a range of factors, breaking the total forecast rebates into a range of categories from most-likely to least-likely. In the step 1209, this analysis is made available to financing partners to identify potential financial products in which forecast cash flows may be bundled for third-party clients.

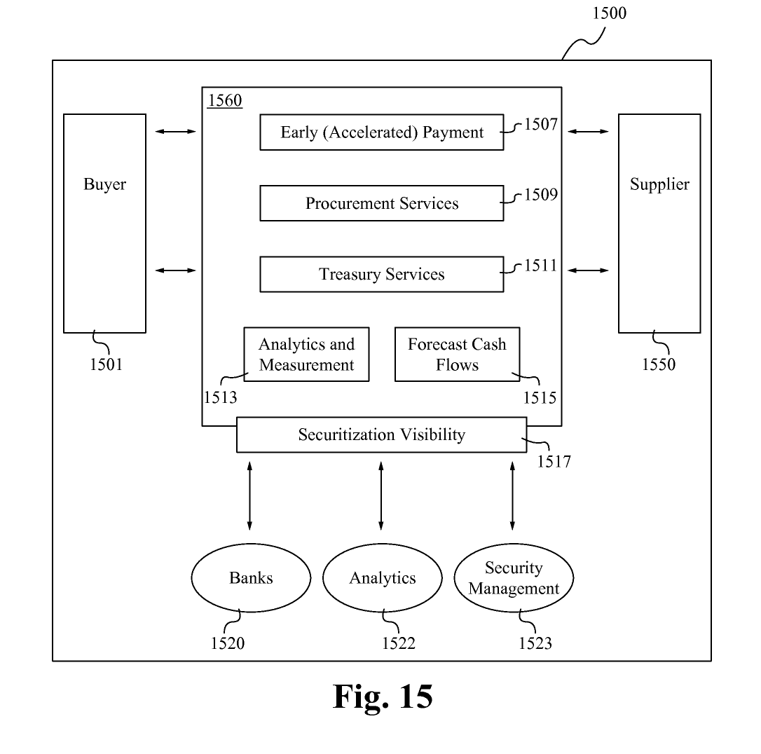

FIG. 13 shows a table 1300 used to illustrate how a confidence level of the payment affects the current value of particular rebates. The table 1300 has rows 1301, 1303, and 1305. The row 1301 shows a rebate with an “unadjusted” present value of $4 million (column 1) and a confidence level of 80% (column 2), indicating an 80% probability that the rebate will be realized. This rebate is categorized as a class “A” rebate (column 3), with an adjusted current value of $4 million*0.8, or $3.2 million (column 4). Similarly, row 1303 shows a rebate with an unadjusted present value of $4 million, categorized as a class “B” rebate (50% probability of being realized), with an adjusted current value of $4 million*0.5, or $2 million. The remaining rows are similarly explained. These rating are used to adjust current values of projected rebates and thus help investors monetize them. Preferably, the table 1300 is stored in a securitization platform, such as on the element 1515 of FIG. 15, discussed below.

As one example, a buyer agrees to purchase from a supplier 10,000 devices per month, for $50 per device, over 5 years. The variable early-payment rebate is 2% if the buyer pays its account in full within 10 days of receiving the invoice. Thus, if the buyer pays early, as agreed, it will receive $10,000 per month over 5 years, or $600,000 over the life of the contract. If, on previous variable early-payment contracts, the buyer typically paid early 80% of the time, an investor may be willing to pay $300,000 today for this expected cash flow.

It will be appreciated that not all procurements are capable of being included in early-payment solutions. As one example, a supplier signs a program agreement with ABC Corp. that has a term of 5 years. ABC Corp. has an annual non-payroll procurement of $2 billion per year, of which $1 billion is capable of being included within the early-payment rebate solution. The remainder is excluded for various reasons, including the suppliers are already paid shortly after invoice submission, knowledge that the suppliers will not accept early-payment rebates, or the cost of on-boarding the underlying suppliers into the program exceeds the potential early-payment benefits.

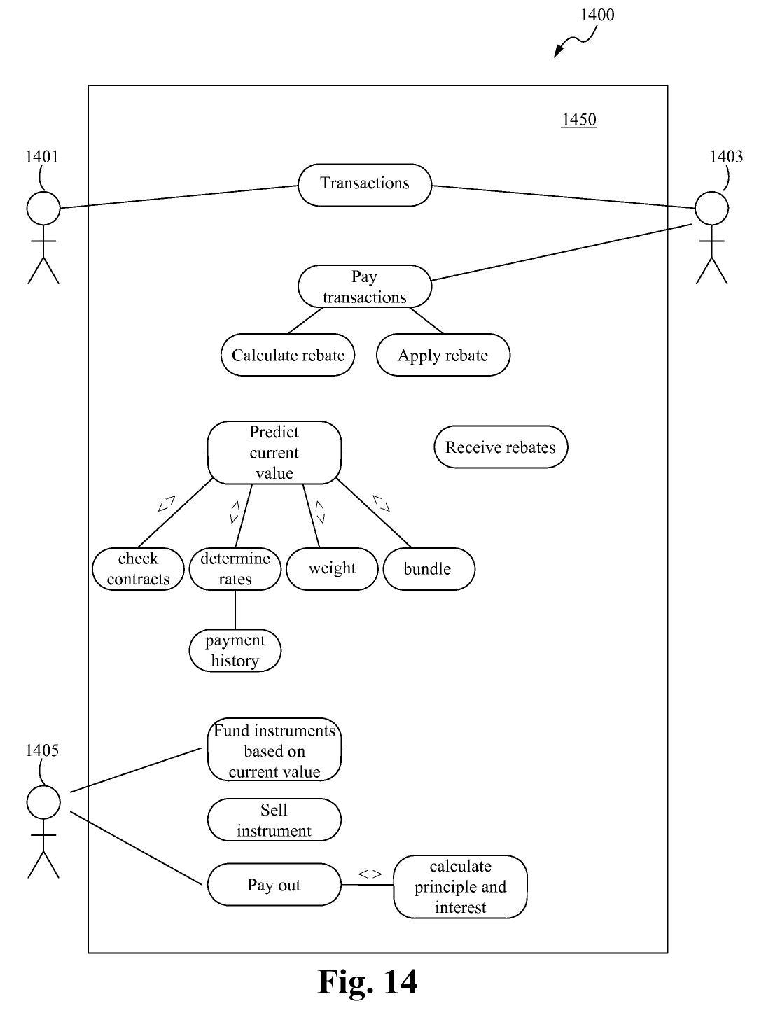

FIG. 14 is a use case diagram 1400 illustrating securitizing variable early-payment rebates in accordance with one embodiment of the invention. The diagram 1400 shows a buyer 1401, a supplier 1403, an investor 1405 and a securitization system 1450, which, for purposes of this example, includes the platform 1001 and the special purpose vehicle 1007, both of FIG. 10. To simplify the diagram 1400, the platform 1450 both processes rebates and issues a financial instrument, though in practice, different systems generally do this. The diagram 1400 shows that the buyer 1401 and the supplier 1403 engage in purchase transactions. The transactions are processed, the rebates are calculated and applied to the transactions, and the supplier receives payment. Using the purchase contract between the buyer 1401 and the supplier 1403, which includes such items as minimum-volume amounts, rebate amounts, and length, the platform 1450 determines the projected value of the rebates. The platform 1450 determines ratings based on the payment history of the buyer 1401, weights the unadjusted current values of the rebates, bundles the pool, and predicts the current value of the bundled pool. This pool is used to secure a financial instrument that is sold to the investor 1405, who receives the rebates as payment for the principle and interest on the financial instrument.

FIG. 15 is a block diagram of a system 1500 illustrating the interactions between a buyer 1501, a supplier 1550, and a securitization platform 1560 in accordance with one embodiment of the invention. The platform 1560 includes an Early (Accelerated) Payment module 1507, a procurement services module 1509, a Treasury Services module 1511, an Analytics and Measurement module 1513, a Forecast Cash Flows module 1515, all coupled through a Securitization Visibility interface 1517 to Banks 1520, Analytics 1522, and Security Management services 1523. In operation, the buyer 1501 and the supplier 1550 negotiate variable early-payment rebates. The Procurement Services module 1509 processes the transactions between the buyer 1501 and the supplier 1550, and the Early (Accelerated) Payment 1507 module applies rebates to these transactions on a per-transaction basis. The Forecast Cash Flows module 1517 projects the cash flows, whose accuracy is determined by ratings and other trend evaluators by the Analytics and Measurement module 1513 to determine current values of the projected rebates. The Treasury Services module 1511 provides investment bank services such as accounts receivable services, accounts payable services, liquidity management services, and reporting services. The entire securitization is made visible through the Securitization Visibility module 1517 to Banks 1520, Third-party analytics 1522 available, for example, to investors, and Security Management services 1523.

Referring to FIGS. 12 and 15, in one embodiment the step 1201 is performed by the Early (Accelerated) Payment module 1507, the step 1203 is performed by the Forecast Cash Flows module 151, the steps 1205 and 1207 are performed by the Analytics and Measurement module 1513, and the step 1209 is performed by the Securitization and Visibility module 1517. It will be appreciated that each of the steps 1200 can include one or more sub steps. Preferably, each of the modules 1507, 1509, 1511, 1513, 1515, and 1517 includes a computer-readable medium for performing each of the recited steps, and the platform 1500 includes one or more processors for executing those steps.

Buyers interact with the platform 1500, which integrates with the existing systems of a large corporation. Suppliers connect to the platform 1500 to provide data or to see their transactions processed and the resulting records displayed. A third party sets parameters and configuration preferences about which financial transaction services are to be invoked during the payment process. The third-party creates and configures these services, either alone or in conjunction with other third parties. When payments are made, they are “augmented” by selected services so that multiple services can be applied. These services include insurance, foreign-exchange services, and commodities services, to name only a few examples. Once the services are performed, appropriate updates take place in the corporation's systems to reflect the new situation.

It will be appreciated that while many of the examples show bundling early-payment rebates between a single buyer and a single supplier, early-payment rebates in accordance with the principles of the invention can be bundled between a buyer and multiple suppliers, or between multiple buyers and multiple suppliers, to form one or any number of financial instruments.

Rebate programs and augmented services are also described in, “Systems for and Methods of Capturing and Analyzing Benefits in Commercial Transactions,” Attorney Docket No. OXYG-00101, by David Brown, Mark Taylor, and Mike Murphy, filed herewith; “Systems for and Methods of Establishing Closed-Loop Business Payment Services,” Attorney Docket No. OXYG-00300, by David Brown, Mark Taylor, Mike Murphy, and Keith Ballantine, filed herewith; and “Systems for and Methods of Augmenting Financial Transactions Services,” Attorney Docket No. OXYG-00400, by David Brown, Mark Taylor, Mike Murphy, and Keith Cotterill, filed herewith, all of which are incorporated by reference in their entireties.

In operation a buyer and one or more suppliers negotiate or renegotiate purchase agreements to include variable early-payment rebates and, optionally, volume discounts. The current value of these rebates is monetized, weighted by the confidence that they will accrue, and bundled into pools sold as financial instruments. The buyer receives cash in the present and the investors, purchasers of these instruments, receive principle and interest payments in the future.

Preferably, a computer platform monetizes the rebates and issues the financial instruments secured by the rebates.

The embodiments given above are shown merely for illustration and are not meant to limit the scope of the invention. It will be readily apparent to one skilled in the art that other modifications may be made to the embodiments without departing from the spirit and scope of the invention as defined by the appended claims.

We claim:

1. A method of securitizing rebate cash flows comprising:
determining, on a computer system, a total amount of variable early-payment rebates for future transactions made under one or more purchase agreements;
determining, on the computer system, a current value of the amount of the variable early-payment rebates; and
issuing a financial instrument secured by the variable-early payment rebates.

2. The method of claim 1, wherein the rebates are larger the earlier in a billing cycle accounts under a corresponding one of the one or more purchase agreements are paid off

3. The method of claim 1, wherein the one or more purchase agreements each has a minimum volume requirement.

4. The method of claim 1, wherein the early-payment rebates are applied to each of the future transactions on a per-transaction basis.

5. The method of claim 1, wherein the financial instrument is a debt instrument in the form of a bond, a note, or a loan.

6. The method of claim 1, wherein each of the variable early-payment rebates is characterized by a rating indicating a confidence that it will be paid by a due date under a corresponding purchase agreement.

7. The method of claim 6, wherein determining the current value comprises weighting each of the variable early-payment rebates by a factor corresponding to its rating.

8. The method of claim 7, wherein the ratings are determined by past payments made by a buyer to a seller under a purchase agreement.

9. The method of claim 1, wherein the future transactions comprise manufacturing expenditures, capital expenditures, payroll expenditures, lease payments, or any combination thereof.

10. The method of claim 1, wherein each of the one or more purchase agreements also has one or more purchase restrictions.

11. The method of claim 10, wherein the one or more purchase restrictions include a limitation on a purchaser, a seller, a product, a service, a number of products or services purchased in a single transaction, a range of dollar amounts, a range of purchase dates, or any combination thereof.

12. The method of claim 1, further comprising, for at least one of the one or more purchase agreements, applying augmented services to each transaction under the purchase agreement.

13. The method of claim 12, wherein the augmented services comprise insurance services, foreign-exchange services, commodities services, or any combination thereof

14. The method of claim 1, wherein at least one of the one or more purchase agreements also contains a volume discount.

15. A system for securitizing variable early-payment rebate cash flows comprising:
a non-transitory memory comprising:
a financial transaction services engine configured to determine a total amount of variable early-payment rebates for future transactions made under one or more purchase agreements;
a calculator configured to determine a current value of the amount of the variable early-payment rebates; and
an issuer configured to issue a financial instrument secured by the variable-early payment rebates.

16. The system of claim 15, wherein the one or more purchase agreements each has a minimum volume requirement and a payment-in-full date

17. The system of claim 15, further comprising a benefits capture service engine configured to apply the early-payment rebates to each transaction under the one or more purchase agreements on a per-transaction basis.

18. The system of claim 15, wherein the financial instrument is a bond or a note.

19. The system of claim 15, wherein each of the variable early-payment rebates is characterized by a rating indicating a confidence that it will be paid by a due date under a corresponding purchase agreement.

20. The system of claim 19, wherein determining the current value comprises weighting each of the variable early-payment rebates by a factor corresponding to its rating.

21. The system of claim 20, wherein the ratings are determined by past payments made by a buyer to a seller under a corresponding one of the one or more purchase agreements.

22. The system of claim 15, further comprising a database of payment histories between a buyer and a supplier.

23. The system of claim 15, wherein the future transactions comprise manufacturing expenditures, capital expenditures, payroll expenditures, lease payments, or any combination thereof.

24. The system of claim 15, wherein at least one of the one or more purchase agreements also has one or more purchase restrictions.

25. The system of claim 24, wherein the one or more purchase restrictions include a limitation on a purchaser, a seller, a product, a service, a number of products or services purchased in a single transaction, a range of dollar amounts, a range of purchase dates, or any combination thereof.

26. The system of claim 15, further comprising a financial transaction services engine configured to apply a service to each of the transactions made under the one or more purchase agreements.

27. The system of claim 26, wherein the services comprise insurance services, foreign-exchange services, commodities services, or any combination thereof

28. The system of claim 15, wherein at least one of the one or more purchase agreements also contains a one or more volume discounts.
